(19) United States
(12) Patent Application Publication
(10) Pub. No.: US 2021/0129792 A1
(43) Pub. Date: May 6, 2021

(54) WATCH TYPE TERMINAL

(71) Applicant: LG ELECTRONICS INC., Seoul (KR)

(72) Inventors: Byoungdoo KIM, Seoul (KR); Yonghee LEE, Seoul (KR); Myounghoon KWAK, Seoul (KR)

(73) Assignee: LG ELECTRONICS INC., Seoul (KR)

(21) Appl. No.: 16/475,573

(22) PCT Filed: Jan. 3, 2017
(86) PCT No.: PCT/KR2017/000062

§ 371 Date: Jul. 2, 2019

(51) Int. Cl. B60R 25/04; B60R 25/25; B60R 25/24; G06F 1/16; G04G 21/00; H04W 4/80

(52) U.S. Cl. CPC B60R 25/04; B60R 25/252; H04W 4/80; G06F 1/163; G04G 21/00; B60R 25/241

(57) ABSTRACT

A watch type terminal includes a main body having a first area and a second area; a wireless communication unit mounted on the main body and configured to perform wireless communication with a vehicle; a display unit disposed in the first area; a button unit disposed in the second area, and configured to receive a first control command or a second control command; and a controller configured to in response to the first control command being input on the button unit when the display unit is in a lock state, acquire fingerprint information from the first control command, unlock the lock state of the display unit when the acquired fingerprint information from the first control command matches stored fingerprint information, and determine if a vehicle start signal has been received from the vehicle, in response to the second control command being input on the button unit, acquire fingerprint information from the second control command, and determining if the vehicle start signal has been received while maintaining the lock state of display unit when the acquired fingerprint information from the second control command matches the stored fingerprint information, in response to determining the vehicle start signal has been received, transmit a vehicle starting control command to the vehicle for starting the vehicle when the first control command is input on the button unit, and in response to determining the vehicle start signal has not been received, activate a navigation mode on the display unit.

### CROSS-REFERENCE TO RELATED APPLICATIONS

This application is the National Phase of PCT International Application No. PCT/KR2017/000062 filed on Jan. 3, 2017, the contents of which are incorporated by reference herein in its entirety.

### BACKGROUND OF THE INVENTION

### Field of the Invention

The present disclosure relates to a mobile terminal and a method for controlling the same.

### Discussion of the Related Art

Terminals may be divided into mobile/portable terminals and stationary terminals according to mobility. Also, the mobile terminals may be classified into handheld types and vehicle mount types according to whether or not a user can directly carry.

The terminal has various functions according to development of technologies. For example, a mobile terminal can be allowed to capture still images or moving images, play music or video files, play games, receive broadcast and the like, so as to be implemented as an integrated multimedia player. Efforts are ongoing to support and increase the functionality of terminals. Such efforts include software improvements, as well as changes and improvements in the structural components.

Recently, functions for controlling external devices such as a vehicle and home appliances using a watch type terminal have been developed. Also, a user's demand for easily controlling functions using a watch type terminal is increasing even though a security procedure is required for control functions.

### SUMMARY OF THE INVENTION

One aspect of the present disclosure is to obviate the above-mentioned problem and other drawbacks, namely, to provide a watch type terminal capable of controlling a specific function through user authentication.

In order to achieve this aspect and other advantages, there is provided a watch type terminal including a main body having a first area and a second area bent to each other, a wireless communication unit mounted on the main body and performing wireless communications with a vehicle, a display unit disposed in the first area, a button unit disposed in the second area, receiving a first or second control command distinguished from each other, and acquiring fingerprint information based on the first or second control command in a lock state, and a controller configured to unlock the lock state when the first control command is applied, and to control the wireless communication unit so as to receive a vehicle start signal. The controller may control the wireless communication unit to receive the vehicle start signal while maintaining the lock state when the control command is the second control command. Accordingly, there is no need to execute a function or repeat a user authentication procedure for controlling a vehicle. Thus, a user can control his or her vehicle more easily and conveniently.

In one embodiment, iris information through a camera may be used for a user authentication procedure.

In one embodiment, a different mode may be executed based on movement of a main body of a watch type terminal. Accordingly, a user can be provided with a necessary function more quickly while driving.

### Advantageous Effects

According to the present disclosure, a control command can be easily applied without an additional control command input as a vehicle control function of a watch type terminal is activated by fingerprint information and iris information.

Further, since a different mode is executed based on movement of a main body of a watch type terminal, a driver can change a necessary function based on the movement of the main body.

### BRIEF DESCRIPTION OF THE DRAWINGS

FIG. 1A is a block diagram illustrating components of a watch type terminal according to one embodiment of the present disclosure.

FIG. 1B is a view of a watch type terminal according to one embodiment, viewed from one direction.

FIG. 2 is a partial exploded view of the watch type terminal of FIG. 1B.

FIGS. 3A to 3C are conceptual views illustrating a control method of a button unit.

FIG. 4A is a conceptual view illustrating a control method of a watch type terminal in accordance with one embodiment.

FIGS. 4B and 4C are conceptual views illustrating the control method of FIG. 4A.

FIG. 5A is a flowchart illustrating a control method of a watch type terminal in accordance with another embodiment.

FIG. 5B is a conceptual view illustrating the control method of FIG. 5A.

FIG. 6 is a conceptual view illustrating a control method of a watch type terminal in accordance with another embodiment.

### DETAILED DESCRIPTION OF THE EMBODIMENTS

Description will now be given in detail according to exemplary embodiments disclosed herein, with reference to the accompanying drawings. For the sake of brief description with reference to the drawings, the same or equivalent components may be provided with the same or similar reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In describing the present disclosure, if a detailed explanation for a related known function or construction is considered to unnecessarily divert the gist of the present disclosure, such explanation has been omitted but would be understood by those skilled in the art. The accompanying drawings are used to help easily understand the technical idea of the present disclosure and it should be understood that the idea of the present disclosure is not limited by the accompanying drawings. The idea of the present disclosure should be construed to extend to any alterations, equivalents and substitutes besides the accompanying drawings.

Mobile terminals presented herein may be implemented using a variety of different types of terminals. Examples of such terminals include cellular phones, smart phones, user equipment, laptop computers, digital broadcast terminals, personal digital assistants (PDAs), portable multimedia players (PMPs), navigators, portable computers (PCs), slate PCs, tablet PCs, ultra books, wearable devices (for example, smart watches, smart glasses, head mounted displays (HMDs)), and the like.

By way of non-limiting example only, further description will be made with reference to particular types of mobile terminals. However, such teachings apply equally to other types of terminals, such as those types noted above. In addition, these teachings may also be applied to stationary terminals such as digital TV, desktop computers, and the like.

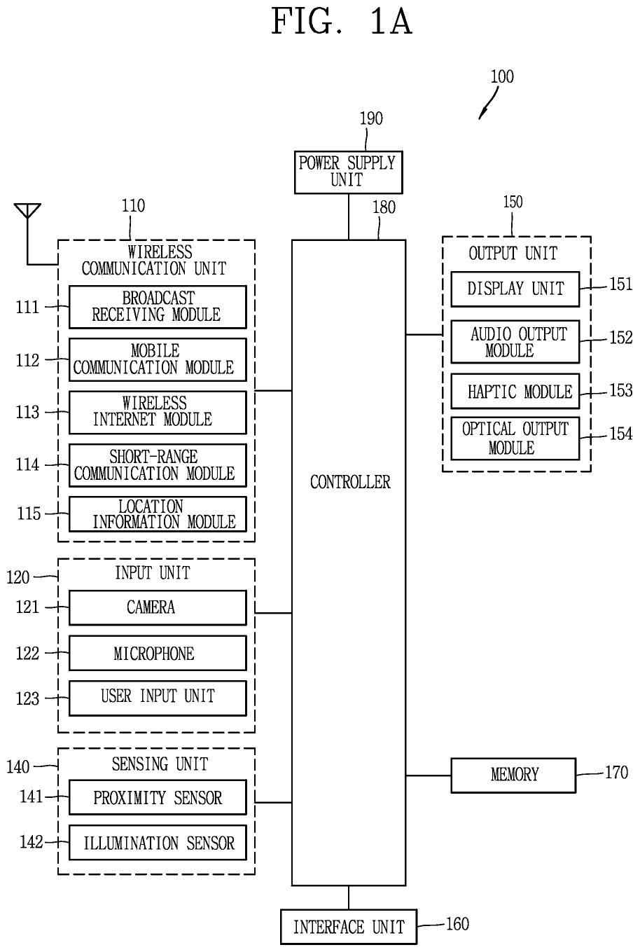

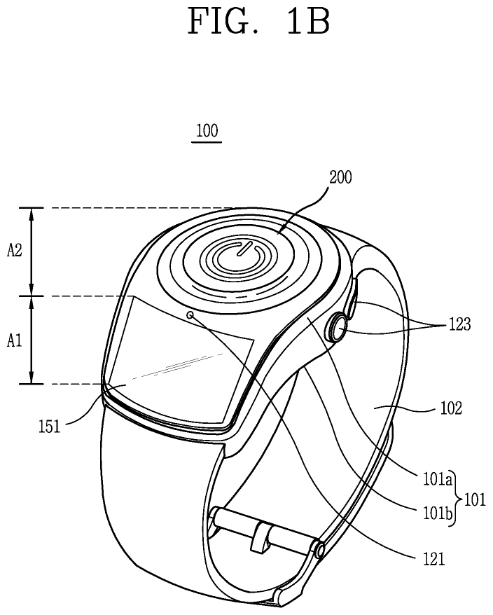

FIG. 1A is a block diagram of a mobile terminal 100 in accordance with one exemplary embodiment of the present disclosure.

The mobile terminal 100 may be shown having components such as a wireless communication unit 110, an input unit 120, a sensing unit 140, an output unit 150, an interface unit 160, a memory 170, a controller (control unit) 180, and a power supply unit 190. FIG. 1 shows the mobile terminal 100 having various components, but it may be understood that implementing all of the illustrated components is not a requirement. Greater or fewer components may alternatively be implemented.

In more detail, the wireless communication unit 110 may typically include one or more modules which permit communications such as wireless communications between the mobile terminal 100 and a wireless communication system, communications between the mobile terminal 100 and another mobile terminal, or communications between the mobile terminal 100 and an external server. Further, the wireless communication unit 110 may typically include one or more modules which connect the mobile terminal 100 to one or more networks.

The wireless communication unit 110 may include one or more of a broadcast receiving module 111, a mobile communication module 112, a wireless Internet module 113, a short-range communication module 114, and a location information module 115.

The input unit 120 may include a camera 121 or an image input unit for obtaining images or video, a microphone 122, which is one type of audio input device for inputting an audio signal, and a user input unit 123 (for example, a touch key, a mechanical key, and the like) for allowing a user to input information. Data (for example, audio, video, image, and the like) may be obtained by the input unit 120 and may be analyzed and processed according to user commands.

The sensing unit 140 may typically be implemented using one or more sensors configured to sense internal information of the mobile terminal 100, the surrounding environment of the mobile terminal 100, user information, and the like. For example, the sensing unit 140 may include at least one of a proximity sensor 141, an illumination sensor 142, a touch sensor, an acceleration sensor, a magnetic sensor, a G-sensor, a gyroscope sensor, a motion sensor, an RGB sensor, an infrared (IR) sensor, a finger scan sensor, a ultrasonic sensor, an optical sensor (for example, camera 121), a microphone 122, a battery gauge, an environment sensor (for example, a barometer, a hygrometer, a thermometer, a radiation detection sensor, a thermal sensor, and a gas sensor, among others), and a chemical sensor (for example, an electronic nose, a health care sensor, a biometric sensor, and the like). The mobile terminal disclosed herein may be configured to utilize information obtained from one or more sensors of the sensing unit 140, and combinations thereof.

The output unit 150 may typically be configured to output various types of information, such as audio, video, tactile output, and the like. The output unit 150 may be shown having at least one of a display unit 151, an audio output module 152, a haptic module 153, and an optical output module 154. The display unit 151 may have an inter-layered structure or an integrated structure with a touch sensor in order to implement a touch screen. The touch screen may function as the user input unit 123 which provides an input interface between the mobile terminal 100 and the user and simultaneously provide an output interface between the mobile terminal 100 and a user.

The interface unit 160 serves as an interface with various types of external devices that are coupled to the mobile terminal 100. The interface unit 160, for example, may include any of wired or wireless ports, external power supply ports, wired or wireless data ports, memory card ports, ports for connecting a device having an identification module, audio input/output (I/O) ports, video I/O ports, earphone ports, and the like. In some cases, the mobile terminal 100 may perform assorted control functions associated with a connected external device, in response to the external device being connected to the interface unit 160.

The memory 170 is typically implemented to store data to support various functions or features of the mobile terminal 100. For instance, the memory 170 may be configured to store application programs executed in the mobile terminal 100, data or instructions for operations of the mobile terminal 100, and the like. Some of these application programs may be downloaded from an external server via wireless communication. Other application programs may be installed within the mobile terminal 100 at time of manufacturing or shipping, which is typically the case for basic functions of the mobile terminal 100 (for example, receiving a call, placing a call, receiving a message, sending a message, and the like). It is common for application programs to be stored in the memory 170, installed in the mobile terminal 100, and executed by the controller 180 to perform an operation (or function) for the mobile terminal 100.

The controller 180 typically functions to control an overall operation of the mobile terminal 100, in addition to the operations associated with the application programs. The controller 180 may provide or process information or functions appropriate for a user by processing signals, data, information and the like, which are input or output by the aforementioned various components, or activating application programs stored in the memory 170.

Also, the controller 180 may control at least some of the components illustrated in FIG. 1A, to execute an application program that have been stored in the memory 170. In addition, the controller 180 may control at least two of those components included in the mobile terminal 100 to activate the application program.

The power supply unit 190 may be configured to receive external power or provide internal power in order to supply appropriate power required for operating elements and components included in the wearable device 100, under the control of the controller 180. The power supply unit 190 may include a battery, and the battery may be configured as an embedded battery or a detachable battery.

At least part of the components may cooperatively operate to implement an operation, a control or a control method of the mobile terminal 100 according to various embodiments disclosed herein. Also, the operation, the control or the control method of the mobile terminal 100 may be implemented on electronic device by an activation of at least one application program stored in the memory 170.

Hereinafter, description will be given in more detail of the aforementioned components with reference to FIG. 1, prior to describing various embodiments implemented through the mobile terminal 100.

First, regarding the wireless communication unit 110, the broadcast receiving module 111 is typically configured to receive a broadcast signal and/or broadcast associated information from an external broadcast managing entity via a broadcast channel. The broadcast channel may include a satellite channel, a terrestrial channel, or both. In some embodiments, two or more broadcast receiving modules may be utilized to facilitate simultaneous reception of two or more broadcast channels, or to support switching among broadcast channels.

The mobile communication module 112 may transmit and/or receive wireless signals to and from one or more network entities. Typical examples of a network entity include a base station, an external mobile terminal, a server, and the like. Such network entities form part of a mobile communication network, which is constructed according to technical standards or communication methods for mobile communications (for example, Global System for Mobile Communication (GSM), Code Division Multi Access (CDMA), CDMA2000 (Code Division Multi Access 2000), EV-DO (Enhanced Voice-Data Optimized or Enhanced Voice-Data Only), Wideband CDMA (WCDMA), High Speed Downlink Packet access (HSDPA), HSDPA (High Speed Uplink Packet Access), Long Term Evolution (LTE), LTE-A (Long Term Evolution-Advanced), and the like).

The wireless signal may include various types of data depending on a voice call signal, a video call signal, or a text/multimedia message transmission/reception.

The wireless Internet module 113 refers to a module for wireless Internet access. This module may be internally or externally coupled to the mobile terminal 100. The wireless Internet module 113 may transmit and/or receive wireless signals via communication networks according to wireless Internet technologies.

Examples of such wireless Internet access include Wireless LAN (WLAN), Wireless Fidelity (Wi-Fi), Wi-Fi Direct, Digital Living Network Alliance (DLNA), Wireless Broadband (WiBro), Worldwide Interoperability for Microwave Access (WiMAX), High Speed Downlink Packet Access (HSDPA), High Speed Uplink Packet Access (HSUPA), Long Term Evolution (LTE), LTE-advanced (LTE-A) and the like. The wireless Internet module 113 may transmit/receive data according to one or more of such wireless Internet technologies, and other Internet technologies as well.

When the wireless Internet access is implemented according to, for example, WiBro, HSDPA, HSUPA, GSM, CDMA, WCDMA, LTE, LTE-A and the like, as part of a mobile communication network, the wireless Internet module 113 performs such wireless Internet access. As such, the Internet module 113 may cooperate with, or function as, the mobile communication module 112.

The short-range communication module 114 is configured to facilitate short-range communications. Suitable technologies for implementing such short-range communications include BLUETOOTH™, Radio Frequency IDentification (RFID), Infrared Data Association (IrDA), Ultra-WideBand (UWB), ZigBee, Near Field Communication (NFC), Wireless-Fidelity (Wi-Fi), Wi-Fi Direct, Wireless USB (Wireless Universal Serial Bus), and the like. The short-range communication module 114 in general supports wireless communications between the mobile terminal 100 and a wireless communication system, communications between the mobile terminal 100 and another mobile terminal 100, or communications between the mobile terminal and a network where another mobile terminal 100 (or an external server) is located, via wireless area networks. One example of the wireless area networks is a wireless personal area networks.

Here, another electronic device may be a wearable device, for example, a smart watch, a smart glass or a head mounted display (HMD), which is able to exchange data with the mobile terminal 100 (or otherwise cooperate with the mobile terminal 100). The short-range communication module 114 may sense or recognize the wearable device, and permit communication between the wearable device and the mobile terminal 100. In addition, when the sensed wearable device is a device which is authenticated to communicate with the mobile terminal 100, the controller 180, for example, may cause transmission of at least part of data processed in the mobile terminal 100 to the wearable device via the short-range communication module 114. Hence, a user of the wearable device may use the data processed in the mobile terminal 100 on the wearable device. For example, when a call is received in the mobile terminal 100, the user may answer the call using the wearable device. Also, when a message is received in the mobile terminal 100, the user can check the received message using the wearable device.

The location information module 115 is generally configured to detect, calculate, derive or otherwise identify a position (or current position) of the mobile terminal 100. As an example, the location information module 115 includes a Global Position System (GPS) module, a Wi-Fi module, or both. For example, when the mobile terminal 100 uses a GPS module, a position of the mobile terminal 100 may be acquired using a signal sent from a GPS satellite. As another example, when the mobile terminal 100 uses the Wi-Fi module, a position of the mobile terminal 100 may be acquired based on information related to a wireless access point (AP) which transmits or receives a wireless signal to or from the Wi-Fi module. If desired, the location information module 115 may alternatively or additionally perform a function of any of the other modules of the wireless communication unit 110 to obtain data related to the position of the mobile terminal 100. The location information module 115 is a module used for acquiring the position (or the current position) of the mobile terminal 100, and may not be limited to a module for directly calculating or acquiring the position of the electronic device.

Next, the input unit 120 is for inputting image information (or signal), audio information (or signal), data, or information input from a user. For inputting image information, the mobile terminal 100 may be provided with a plurality of cameras 121. Such cameras 121 may process image frames of still pictures or video obtained by image sensors in a video or image capture mode. The processed image frames can be displayed on the display unit 151 or stored in memory 170. Meanwhile, the cameras 121 provided in the mobile terminal 100 may be arranged in a matrix configuration to permit a plurality of image information having various angles or focal points to be input to the mobile terminal 100. Also, the cameras 121 may be located in a stereoscopic arrangement to acquire left and right images for implementing a stereoscopic image.

The microphone 122 processes an external audio signal into electric audio (sound) data. The processed audio data can be processed in various manners according to a function being executed in the mobile terminal 100. If desired, the microphone 122 may include assorted noise removing algorithms to remove unwanted noise generated in the course of receiving the external audio signal.

The user input unit 123 is a component that permits input by a user. Such user input may enable the controller 180 to control operation of the mobile terminal 100. The user input unit 123 may include one or more of a mechanical input element (for example, a mechanical key, a button located on a front and/or rear surface or a side surface of the mobile terminal 100, a dome switch, a jog wheel, a jog switch, and the like), or a touch-sensitive input element, among others. As one example, the touch-sensitive input element may be a virtual key, a soft key or a visual key, which is displayed on a touch screen through software processing, or a touch key which is located on the electronic device at a location that is other than the touch screen. On the other hand, the virtual key or the visual key may be displayed on the touch screen in various shapes, for example, graphic, text, icon, video, or a combination thereof.

The sensing unit 140 is generally configured to sense one or more of internal information of the mobile terminal 100, surrounding environment information of the mobile terminal 100, user information, or the like, and generates a corresponding sensing signal. The controller 180 generally cooperates with the sending unit 140 to control operations of the mobile terminal 100 or execute data processing, a function or an operation associated with an application program installed in the mobile terminal based on the sensing signal. The sensing unit 140 may be implemented using any of a variety of sensors, some of which will now be described in more detail.

The proximity sensor 141 refers to a sensor to sense presence or absence of an object approaching a surface, or an object located near a surface, by using an electromagnetic field, infrared rays, or the like without a mechanical contact. The proximity sensor 141 may be arranged at an inner region of the mobile terminal 100 covered by the touch screen, or near the touch screen.

The proximity sensor 141, for example, may include any of a transmissive type photoelectric sensor, a direct reflective type photoelectric sensor, a mirror reflective type photoelectric sensor, a high-frequency oscillation proximity sensor, a capacitance type proximity sensor, a magnetic type proximity sensor, an infrared rays proximity sensor, and the like. When the touch screen is implemented as a capacitance type, the proximity sensor 141 can sense proximity of a pointer relative to the touch screen by changes of an electromagnetic field, which is responsive to an approach of an object with conductivity. In this case, the touch screen (touch sensor) may also be categorized as a proximity sensor.

The term “proximity touch” will often be referred to herein to denote the scenario in which a pointer is positioned to be proximate to the touch screen without contacting the touch screen. The term “contact touch” will often be referred to herein to denote the scenario in which a pointer makes physical contact with the touch screen. For the position corresponding to the proximity touch of the pointer relative to the touch screen, such position will correspond to a position where the pointer is perpendicular to the touch screen. The proximity sensor 141 may sense proximity touch, and proximity touch patterns (for example, distance, direction, speed, time, position, moving status, and the like). In general, the controller 180 may process data corresponding to proximity touches and proximity touch patterns sensed by the proximity sensor 141, and cause visual information corresponding to the processed data to be output on the touch screen. In addition, the controller 180 can control the mobile terminal 100 to execute different operations or process different data (or information) according to whether a touch with respect to a point on the touch screen is either a proximity touch or a contact touch.

A touch sensor senses a touch (or a touch input) applied to the touch screen (or the display unit 151) using any of a variety of touch methods. Examples of such touch methods include a resistive type, a capacitive type, an infrared type, and a magnetic field type, among others.

As one example, the touch sensor may be configured to convert changes of pressure applied to a specific part of the display unit 151, or convert capacitance occurring at a specific part of the touch screen, into electric input signals. The touch sensor may also be configured to sense not only a touched position and a touched area, but also touch pressure and/or touch capacitance. A touch object is generally used to apply a touch input to the touch sensor. Examples of typical touch objects include a finger, a touch pen, a stylus pen, a pointer, or the like.

When a touch input is sensed by a touch sensor, corresponding signals may be transmitted to a touch controller. The touch controller may process the received signals, and then transmit corresponding data to the controller 180. Accordingly, the controller 180 may sense which region of the display unit 151 has been touched. Here, the touch controller may be a component separate from the controller 180, the controller 180, and combinations thereof.

Meanwhile, the controller 180 may execute the same or different controls according to a type of touch object that touches the touch screen or a touch key provided in addition to the touch screen. Whether to execute the same or different control according to the object which provides a touch input may be decided based on a current operating state of the mobile terminal 100 or a currently executed application program, for example.

The touch sensor and the proximity sensor may be implemented individually, or in combination, to sense various types of touches. Such touches include a short (or tap) touch, a long touch, a multi-touch, a drag touch, a flick touch, a pinch-in touch, a pinch-out touch, a swipe touch, a hovering touch, and the like.

If desired, an ultrasonic sensor may be implemented to recognize location information relating to a touch object using ultrasonic waves. The controller 180, for example, may calculate a position of a wave generation source based on information sensed by an illumination sensor and a plurality of ultrasonic sensors. Since light is much faster than ultrasonic waves, the time for which the light reaches the optical sensor is much shorter than the time for which the ultrasonic wave reaches the ultrasonic sensor. The position of the wave generation source may be calculated using this fact. For instance, the position of the wave generation source may be calculated using the time difference from the time that the ultrasonic wave reaches the sensor based on the light as a reference signal.

The camera 121, which has been depicted as a component of the input unit 120, typically includes at least one a camera sensor (CCD, CMOS etc.), a photo sensor (or image sensors), and a laser sensor.

Implementing the camera 121 with a laser sensor may allow detection of a touch of a physical object with respect to a 3D stereoscopic image. The photo sensor may be laminated on, or overlapped with, the display device. The photo sensor may be configured to scan movement of the object in vicinity of the touch screen. In more detail, the photo sensor may include photo diodes and transistors (TRs) at rows and columns to scan content received at the photo sensor using an electrical signal which changes according to the quantity of applied light. Namely, the photo sensor may calculate the coordinates of the physical object according to variation of light to thus obtain location information of the physical object.

The display unit 151 is generally configured to output information processed in the mobile terminal 100. For example, the display unit 151 may display execution screen information of an application program executing at the mobile terminal 100 or user interface (UI) and graphic user interface (GUI) information in response to the execution screen information.

Also, the display unit 151 may be implemented as a stereoscopic display unit for displaying stereoscopic images.

A typical stereoscopic display unit may employ a stereoscopic display scheme such as a stereoscopic scheme (a glass scheme), an auto-stereoscopic scheme (glassless scheme), a projection scheme (holographic scheme), or the like.

The audio output module 152 may receive audio data from the wireless communication unit 110 or output audio data stored in the memory 170 during modes such as a signal reception mode, a call mode, a record mode. a voice recognition mode, a broadcast reception mode, and the like. The audio output module 152 can provide audible output related to a particular function (e.g., a call signal reception sound, a message reception sound, etc.) performed by the mobile terminal 100. The audio output module 152 may also be implemented as a receiver, a speaker, a buzzer, or the like.

A haptic module 153 can be configured to generate various tactile effects that a user feels, perceives, or otherwise experiences. A typical example of a tactile effect generated by the haptic module 153 is vibration. The strength, pattern and the like of the vibration generated by the haptic module 153 can be controlled by user selection or setting by the controller. For example, the haptic module 153 may output different vibrations in a combining manner or a sequential manner.

Besides vibration, the haptic module 153 can generate various other tactile effects, including an effect by stimulation such as a pin arrangement vertically moving to contact skin, a spray force or suction force of air through a jet orifice or a suction opening, a touch to the skin, a contact of an electrode, electrostatic force, an effect by reproducing the sense of cold and warmth using an element that can absorb or generate heat, and the like.

The haptic module 153 can also be implemented to allow the user to feel a tactile effect through a muscle sensation such as the user's fingers or arm, as well as transferring the tactile effect through direct contact. Two or more haptic modules 153 may be provided according to the particular configuration of the mobile terminal 100.

An optical output module 154 may output a signal for indicating an event generation using light of a light source of the mobile terminal 100. Examples of events generated in the mobile terminal 100 may include message reception, call signal reception, a missed call, an alarm, a schedule notice, an email reception, information reception through an application, and the like.

A signal output by the optical output module 154 may be implemented in such a manner that the mobile terminal 100 emits monochromatic light or light with a plurality of colors to a front or rear surface. The signal output may be terminated as the mobile terminal 100 senses that a user has checked the generated event, for example.

The interface unit 160 serves as an interface for external devices to be connected with the mobile terminal 100. For example, the interface unit 160 can receive data transmitted from an external device, receive power to transfer to elements and components within the mobile terminal 100, or transmit internal data of the mobile terminal 100 to such external device. The interface unit 160 may include wired or wireless headset ports, external power supply ports, wired or wireless data ports, memory card ports, ports for connecting a device having an identification module, audio input/output (I/O) ports, video I/O ports, earphone ports, or the like.

The identification module may be a chip that stores various information for authenticating authority of using the mobile terminal 100 and may include a user identity module (UIM), a subscriber identity module (SIM), a universal subscriber identity module (USIM), and the like. In addition, the device having the identification module (also referred to herein as an “identifying device”) may take the form of a smart card. Accordingly, the identifying device can be connected with the mobile terminal 100 via the interface unit 160.

When the mobile terminal 100 is connected with an external cradle, the interface unit 160 can serve as a passage to allow power from the cradle to be supplied to the mobile terminal 100 or may serve as a passage to allow various command signals input by the user from the cradle to be transferred to the mobile terminal therethrough. Various command signals or power input from the cradle may operate as signals for recognizing that the mobile terminal is properly mounted on the cradle.

The memory 170 can store programs to support operations of the controller 180 and store input/output data (for example, phonebook, messages, still images, videos, etc.). The memory 170 may store data related to various patterns of vibrations and audio which are output in response to touch inputs on the touch screen.

The memory 170 may include one or more types of storage mediums including a flash memory type, a hard disk type, a solid state disk (SSD) type, a silicon disk drive (SDD) type, a multimedia card micro type, a card-type memory (e.g., SD or DX memory, etc.), a Random Access Memory (RAM), a Static Random Access Memory (SRAM), a Read-Only Memory (ROM), an Electrically Erasable Programmable Read-Only Memory (EEPROM), a Programmable Read-Only memory (PROM), a magnetic memory, a magnetic disk, an optical disk, and the like. The mobile terminal 100 may also be operated in relation to a network storage device that performs the storage function of the memory 170 over a network, such as the Internet.

The controller 180 may typically control operations relating to application programs and the general operations of the mobile terminal 100. For example, the controller 180 may set or release a lock state for restricting a user from inputting a control command with respect to applications when a status of the mobile terminal 100 meets a preset condition.

The controller 180 can also perform the controlling and processing associated with voice calls, data communications, video calls, and the like, or perform pattern recognition processing to recognize a handwriting input or a picture drawing input performed on the touch screen as characters or images, respectively. In addition, the controller 180 can control one or a combination of those components in order to implement various exemplary embodiments disclosed herein.

The power supply unit 190 receives external power or provides internal power and supply the appropriate power required for operating respective elements and components included in the wearable device 100 under the control of the controller 180. The power supply unit 190 may include a battery, which is typically rechargeable or be detachably coupled to the terminal body for charging.

The power supply unit 190 may include a connection port. The connection port may be configured as one example of the interface unit 160 to which an external charger for supplying power to recharge the battery is electrically connected.

As another example, the power supply unit 190 may be configured to recharge the battery in a wireless manner without use of the connection port. In this example, the power supply unit 190 can receive power, transferred from an external wireless power transmitter, using at least one of an inductive coupling method which is based on magnetic induction or a magnetic resonance coupling method which is based on electromagnetic resonance.

Various embodiments described herein may be implemented in a computer-readable medium, a machine-readable medium, or similar medium using, for example, software, hardware, or any combination thereof.

FIG. 1B is a view of a watch type terminal according to one embodiment, viewed from one direction.

Referring to FIG. 1B, a watch type terminal 100 includes a main body provided with a display unit 151, and a band 102 connected to the main body so as to be worn on a wrist.

The main body includes a case 101 forming an outer appearance. As illustrated, the case 101 may include a first case 101a and a second case 101b cooperatively defining an inner space for accommodating various electronic components. However, the present disclosure is not limited to this, and one case may be configured to define the inner space, thereby implementing a terminal 100 with a uni-body.

The watch type terminal 100 may perform wireless communication, and an antenna for the wireless communication may be installed in the main body. On the other hand, the antenna may extend its function using the case. For example, a case including a conductive material may be electrically connected to the antenna to extend a ground area or a radiation area.

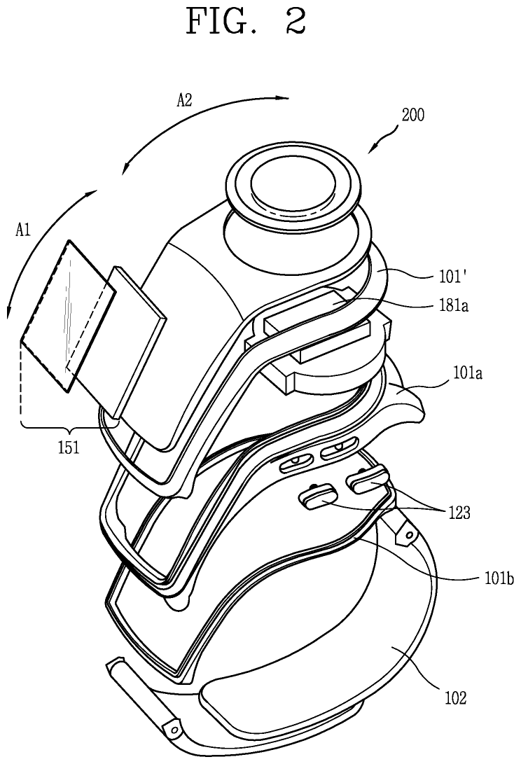

The display unit 151 may include a touch sensor to be implemented as a touch screen. As illustrated, a window 151a (see FIG. 2) of the display unit 151 may be mounted on the first case 101a to form a front surface of the terminal body together with the first case 101a.

The band 102 may be worn on the wrist so as to surround the wrist, and may be formed of a flexible material for easy wearing. As an example, the band 102 may be formed of leather, rubber, silicone, synthetic resin, or the like. The band 102 may be detachably attached to the main body, and may be configured to be replaceable with various types of bands according to the user's preference.

The watch type terminal 100 according to the present disclosure further includes a button unit 200 exposed from the first case 101a. The display unit 151 may be disposed in a first area (or region) A1 of the main body of the watch type terminal 100, and the button unit 200 may be disposed in a second area (or region) A2 of the main body.

The main body may be divided into a first area A1 and a second area A2 based on a bent area, and the first and second areas A1, A2 are located in different visual field ranges from user's eyes (sight).

The main body may include a camera 121, a user input unit 123, and the like. When the display unit 151 is implemented as a touch screen, the display unit 151 may function as a user input unit 123, so that the main body may not have a separate key.

The camera 121 may be disposed between the first and second areas A1 and A2, that is, between the display unit 151 and the button unit 200. The camera 121 is controlled to image an external environment or to acquire iris information of a user.

FIG. 2 is a partial exploded view of the watch type terminal of FIG. 1B.

Referring to FIG. 2, the watch type terminal includes a first case 101a on which the display unit 151 and the button unit 200 are placed, and a second case 101b coupled to the first case 101a so as to form an inner space. The second case 101b may be in the form of a cover that covers a rear surface of the first case 101a.

The display unit 151 having a touch sensing layer and a display module is placed on the first case 101a, and the window 151a is coupled to the first case 101a by covering the display unit 151. The first case 101a includes an opening hole through which the button unit 200 is mounted. The window 151a may be formed to cover the remaining areas of the first case 101a except the area corresponding to the opening hole.

One area of the first case 101a is bent so as to form the first and second areas A1, A2. The display unit 151 is disposed in the first area A1 of the first case 101a, and the button unit 200 is disposed in the second area A2 of the first case 101a. The first and second areas A1, A2 is bent at a predetermined curvature. When worn on the user's wrist, the first and second areas A1, A2 may be disposed according to a curvature of the wrist.

A metal decoration 101′ is disposed along an edge of the first case 101a. The metal decoration 101′ may be formed to surround the window 151a, and may be formed according to a curvature of the first case 101a.

A circuit board 181a and a battery are disposed in an inner space defined by the first and second cases 101a, 101b.

A user input unit 123 may be disposed on a side surface of the first case 101a, and the user input unit 123 may generate a control command in a pressable manner or a touch manner for receiving a touch input.

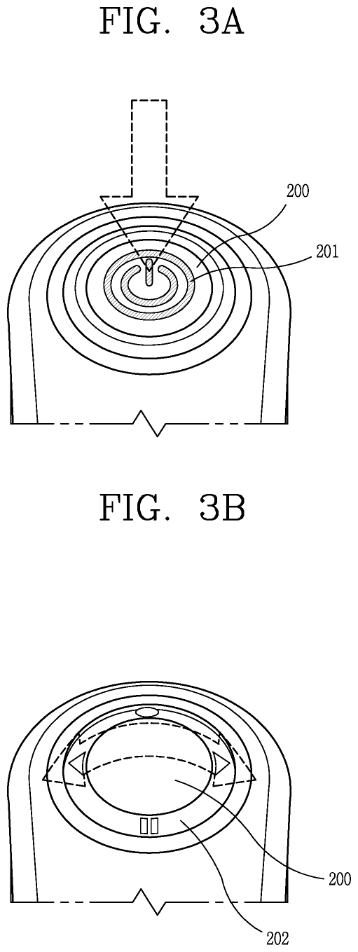

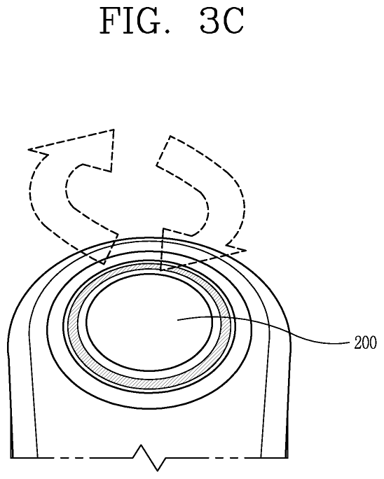

FIGS. 3A to 3C are conceptual views illustrating a control method of a button unit.

Referring to FIG. 3A, the button unit 200 is formed of a pressing key that is physically pressed by an external force. The controller 180 is configured to turn the watch type terminal 100 on/off when the button unit 200 is pressed by an external force. The button unit 200 may further include a lighting module for producing light. The lighting module may produce light of a first pattern 201 when the external force is applied.

Alternatively, the button unit 200 may further include a display module for outputting an image.

Referring to FIG. 3B, the button unit 200 may include a plurality of pressing keys having a specific area asymmetrically pressed with respect to the center. The button unit 200 generates a control command while being pressed obliquely (in a slanting manner) by an external force applied to one area.

In this case, the lighting module may output second patterns 202 indicating different control commands to an edge area of the button unit 200. The controller 180 may selectively generate a control command corresponding to each respective area of the button unit 200.

Referring to FIG. 3C, the button unit 200 may further include a rotation module rotated with respect to one axis by an external force. Although not specifically illustrated in the drawing, a rotation protrusion may be formed on one area of the button unit 200 exposed to the outside so as to rotate the button unit easily.

The controller 180 may generate a control command related to direction, range, and amount adjustments by the rotation of the button unit 200.

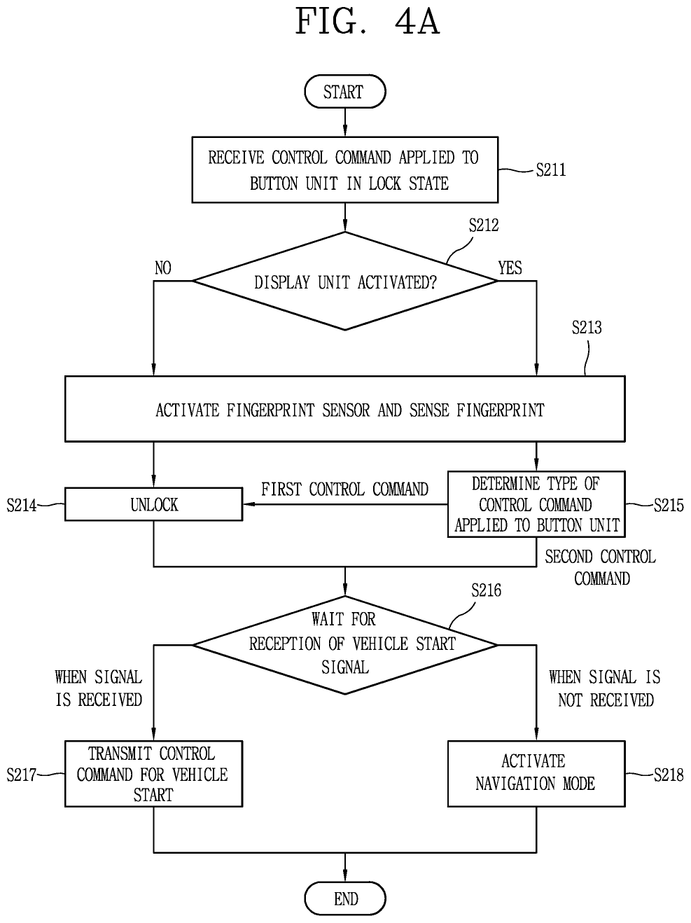

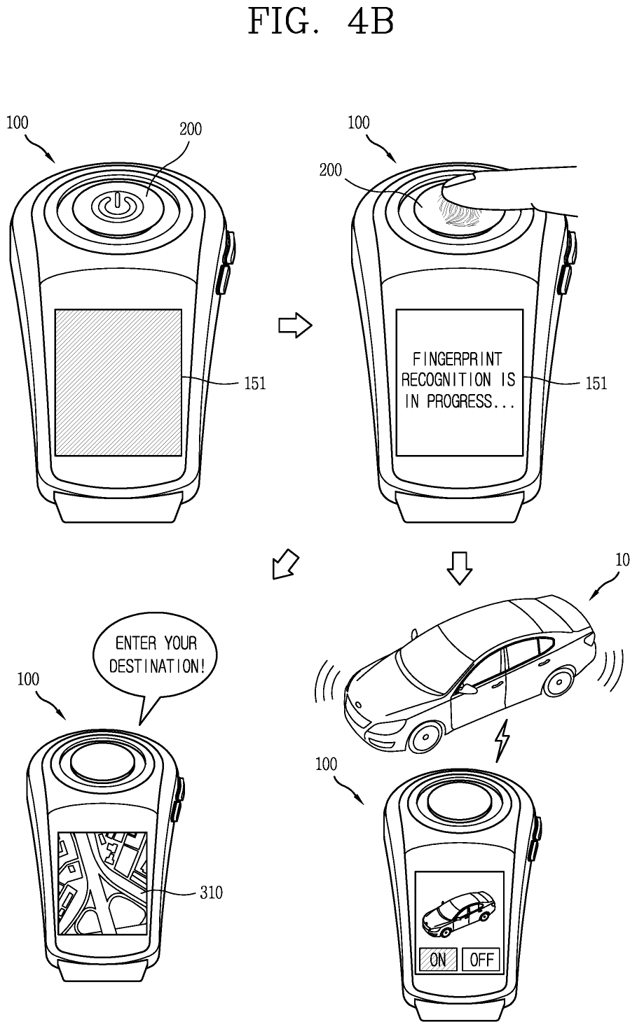

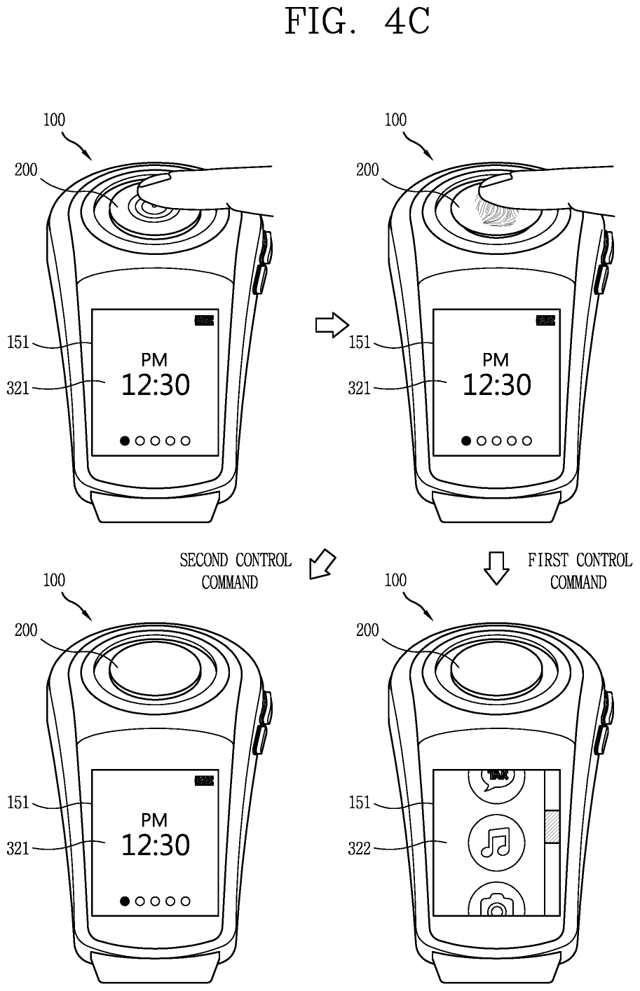

FIG. 4A is a flowchart illustrating a control method of a watch type terminal according to one embodiment of the present disclosure.

FIGS. 4B to 4C are conceptual views illustrating the control method of FIG. 4A.

A watch type terminal 100 according to this embodiment further includes a fingerprint sensor formed to overlap with the button unit 200. The controller 180 activates the fingerprint sensor to acquire fingerprint information when a specific control command is generated or an external force is applied to the button unit 200.

The watch type terminal 100 according to this embodiment may generate a control command for controlling functions of an external device, specifically, a vehicle via wireless communications. However, the external device is not limited to the vehicle, but may be applied to home appliances, another terminal, and the like.

Referring to FIGS. 4A and 4B, a control method of the watch type terminal when a display unit is in a deactivated state will be described.

A control command applied to a button unit is received in a lock state of the watch type terminal 100 (S211). Here, the control command applied to the button unit may correspond to a number of pressed times during a predetermined period of time, a time period during which the button unit is in a pressed state, a specific area (in the case of FIG. 3B) of the button unit to which an external force is applied, a rotation direction of the button unit, rotation speed (in the case of FIG. 3C), and the like.

The controller 180 determines whether the display unit is in an activated state when a control command is applied to the button unit 200 (S212). Here, the activated state corresponds to a state in which the display unit 151 displays specific screen information and receives a touch input. In contrast, the deactivated state may correspond to a state in which no image is displayed from the display unit 151 or a state in which only continuously displayed information (AOD) is output, or a state in which a touch input is not received.

When a control command is applied to the button unit 200 while the display unit 151 is in the deactivated state, the controller 180 activates the fingerprint sensor and acquires fingerprint information (S213).

The display unit 151 may display an indicator indicating that fingerprint recognition is in progress while the fingerprint information is being acquired.

The controller 180 performs a user authentication procedure based on the fingerprint information acquired by the fingerprint sensor. When the fingerprint information acquired by the fingerprint sensor substantially matches previously stored fingerprint data, the controller 180 completes the authentication procedure. Accordingly, the lock state is unlocked (S214).

The watch type terminal 100, which has been unlocked, waits for reception of a vehicle start signal (S216). The controller 180 activates the wireless communication unit 110. For example, the wireless communication unit 110 receives the vehicle start signal from the vehicle using a BT or Wi-Fi communications technology. The wireless communication unit 110 is controlled to receive a vehicle start signal of a vehicle located within a predetermined range from the watch type terminal 100. In addition, the controller 180 detects a vehicle corresponding to vehicle information stored together with fingerprint information acquired by the fingerprint sensor so as to acquire the vehicle start signal.

For example, when the lock state is unlocked, the controller 180 transmits a reception wait signal to an external device located within a predetermined range, and receives device ID information of each external device and a plurality of response signals. Thus, a vehicle start signal of a vehicle, which is selected based on the device ID information included in the received plurality of response signals, may be received.

Upon receiving the vehicle start signal, the controller 180 generates a control command for the vehicle start to transmit it to the vehicle 10. The vehicle 10 is started based on the control command transmitted from the watch type terminal 100.

The display unit 180 may display an image for notifying that the vehicle is started or an image for confirming whether or not to transmit the control command for the vehicle start.

Meanwhile, a navigation mode of the watch type terminal 100 is activated when the vehicle start signal is not received. In the navigation mode, the controller 180 does not transmit a control command to the vehicle 10. The controller 180 may control the wireless communication unit 110 to block communications with the vehicle 10.

Meanwhile, the display unit 180 may display a map screen 310 in the navigation mode. Also, the controller 180 receives an input of destination information and the like.

According to this embodiment, when a preset vehicle is located within a preset range, a control command for a vehicle start signal can be transmitted by a communications method of the wireless communication unit 110. Thus, a user can control his or her vehicle near the vehicle.

In addition, fingerprint-based user authentication is performed to control the vehicle, so a user who can authenticate himself or herself is only allowed to control the vehicle using a watch type terminal.

Referring back to FIGS. 4A and 4C, the controller 180 determines whether the display unit 151 is activated (S212), and activates the fingerprint sensor to sense a fingerprint (S213).

The controller 180 determines a type of control command applied to the button unit 200 (S215). When a first control command is applied to the button unit 200 while the display unit 151 is activated, the controller 180 performs a user authentication procedure using the fingerprint information and unlocks the lock state (S214).

Meanwhile, when a second control command different from the first control command is applied to the button unit 200 while the display unit 151 is activated, the controller 180 waits for the vehicle start signal (S216) without a step of unlocking. For example, the first control command is generated by pressing the button unit 200 once, and the second control command is generated by pressing the button unit 200 two or more times.

The controller 180 unlocks the lock state when different control commands are applied to the button unit 200 in a state that the display unit 151 is activated (S214), or waits for reception of the vehicle start signal (S216). When the second control command is applied, the controller 180 executes a function only related to the vehicle 10 without unlocking the lock state of the watch type terminal 100.

Referring back to FIG. 4C, when a first control command is applied to the button unit 200 while first screen information 321 is being displayed after the display unit 151 is activated, the controller 180 unlocks the lock state and controls the display unit 151 to change the first screen information 321 to second screen information 322.

Here, the first screen information 321 may be a lock screen or may include visual information indicating time when the watch type terminal 100 is locked. The second screen information 321 displayed when unlocked may correspond to a home screen page including at least one icon for executing applications.

Meanwhile, when a second control command is applied to the button unit 200, the controller waits for reception of the vehicle start signal without unlocking. The controller 180 may generate a control command for the vehicle start or activate a navigation mode while unlocked.

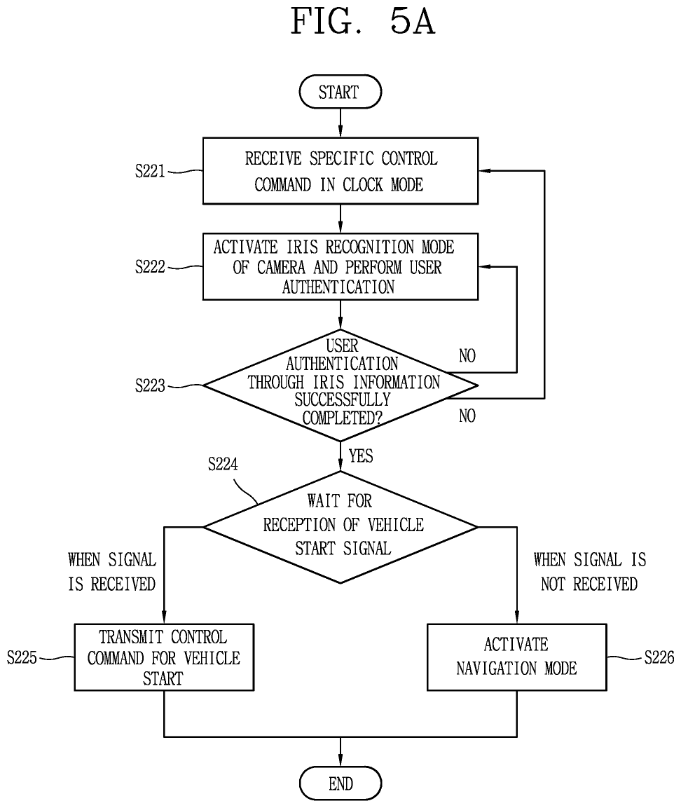

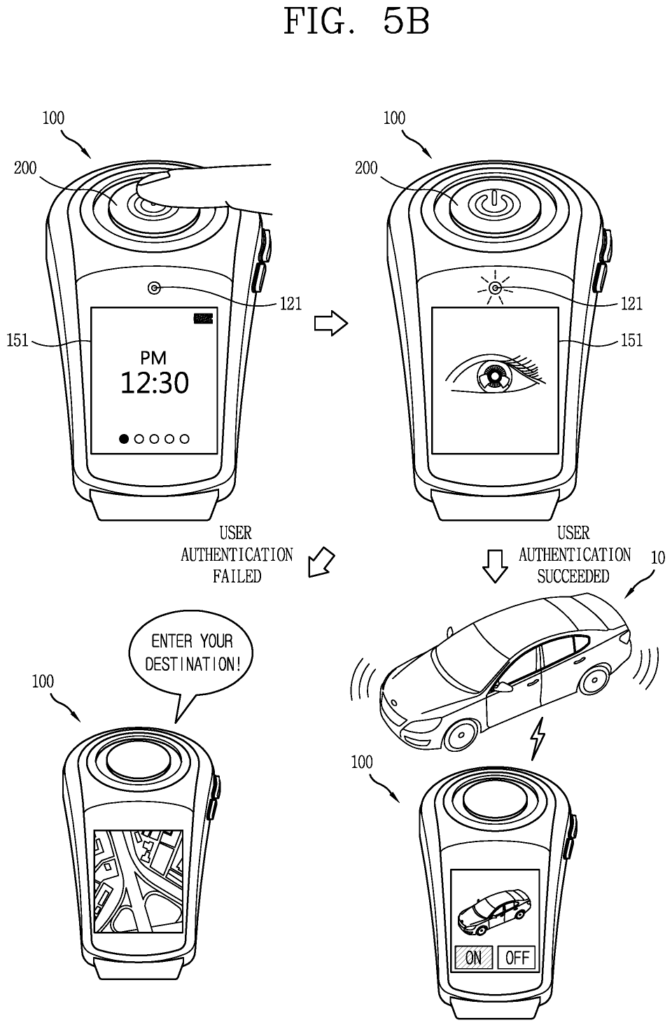

FIG. 5A is a flowchart illustrating a control method of a watch type terminal in accordance with another embodiment of the present disclosure, and FIG. 5B is a conceptual view illustrating the control method of FIG. 5A.

A watch type terminal 100 according to FIGS. 5A and 5B includes a camera 121 for acquiring iris information of a user.

When receiving a specific control command in a clock mode (S221), an iris recognition mode of the camera is activated, and a user authentication procedure is performed (S222). In the clock mode, a display unit 151 of the watch type terminal 100 displays screen information including time information in a lock state or an unlocked state.

The controller 180 determines whether the user authentication is successfully completed based on the iris information (S223). When the authentication is failed, the controller 180 performs a step for acquiring iris information again. In the iris recognition mode, the display unit 151 may display a guide image for instructing a user to position the eyes close to the camera.

The controller 180 waits for reception of a vehicle start signal when the user authentication is successfully completed based on the iris information (S224). The controller 180 controls the wireless communication unit 110 to transmit a control command for the vehicle start when the vehicle start signal is received.

On the other hand, when the vehicle start signal is not received for a predetermined period of time, a navigation mode is activated.

The controller 180 may also activate the navigation mode when the user authentication through the iris information is failed.

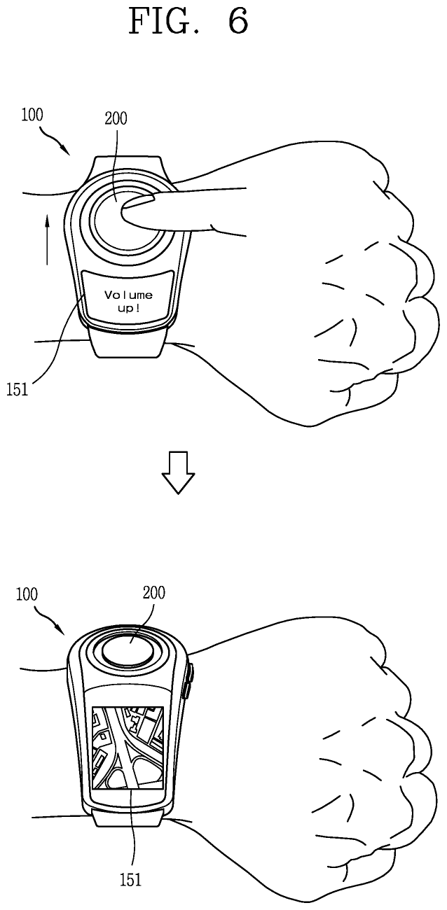

FIG. 6 is a conceptual view illustrating a control method of a watch type terminal in accordance with another embodiment of the present disclosure.

A watch type terminal according to this embodiment further includes a sensor unit for sensing movement of the watch type terminal. The sensor unit may sense rotation of the watch type terminal 100 with it worn on the wrist.

For example, the sensor unit may include a sensor for sensing movement, a sensor for sensing rotation by an image acquired, and a sensor for sensing a relative movement to the wrist. The sensor unit senses the rotation of the watch type terminal 100 with respect to the wrist.

The controller 180 may perform a specific function based on a control command applied to the button unit 200 in a first mode in which the button unit 200 is superimposed on one area of the wrist. For example, it may execute a function of adjusting a volume in response to a control command applied to the button unit 200. In the first mode in which the button unit 200 is disposed on the one area, the display unit 151 is disposed on another area of the wrist so as to face a different direction from the button unit 200.

The sensor unit senses relative rotation of the watch type terminal 100 with respect to the wrist while the main body of the watch type terminal 100 is worn on the wrist. The first mode is switched to a second mode when the controller 180 detects a change in position of the watch type terminal 100 from the wrist.

In the second mode, the display unit 151 is disposed on the one area of the wrist. The controller 180 executes a specific application in the second mode. For example, the second mode may correspond to a navigation mode.

In the second mode, a control command generated by the button unit 200 may be blocked. Although not illustrated in the drawing, the first mode is reactivated when movement of the main body is detected again in the second mode.

According to this embodiment, the control mode can be activated differently based on movement of the main body, and the display unit or the button unit can be selectively utilized.

The present disclosure can be implemented as computer-readable codes in a program-recorded medium. The computer-readable medium may include all types of recording devices each storing data readable by a computer system. Examples of such computer-readable media may include hard disk drive (HDD), solid state disk (SSD), silicon disk drive (SDD), ROM, RAM, CD-ROM, magnetic tape, floppy disk, optical data storage element and the like. Also, the computer-readable medium may also be implemented as a format of carrier wave (e.g., transmission via an Internet). The computer may include the controller 180 of the terminal. Therefore, it should also be understood that the above-described embodiments are not limited by any of the details of the foregoing description, unless otherwise specified, but rather should be construed broadly within its scope as defined in the appended claims, Therefore, all changes and modifications that fall within the metes and bounds of the claims, or equivalents of such metes and bounds are therefore intended to be embraced by the appended claims.

The present disclosure relates to a smartwatch capable of controlling external devices including a vehicle, and may be utilized in various relevant industrial fields.

1-11. (canceled)

12. A watch type terminal, comprising:
a main body having a first area and a second area;
a wireless communication unit mounted on the main body and configured to perform wireless communication with a vehicle;
a display unit disposed in the first area;
a button unit disposed in the second area, and configured to receive a first control command or a second control command; and
a controller configured to:
in response to the first control command being input on the button unit when the display unit is in a lock state, acquire fingerprint information from the first control command, unlock the lock state of the display unit when the acquired fingerprint information from the first control command matches stored fingerprint information, and determine if a vehicle start signal has been received from the vehicle,
in response to the second control command being input on the button unit, acquire fingerprint information from the second control command, and determining if the vehicle start signal has been received while maintaining the lock state of display unit when the acquired fingerprint information from the second control command matches the stored fingerprint information,
in response to determining the vehicle start signal has been received, transmit a vehicle starting control command to the vehicle for starting the vehicle when the first control command is input on the button unit, and
in response to determining the vehicle start signal has not been received, activate a navigation mode on the display unit.

13. The watch type terminal of claim 12, further comprising:
a memory storing the fingerprint information in association with a particular vehicle,
wherein the controller is further configured to transmit the vehicle starting control command to the vehicle when the stored particular vehicle matches the vehicle transmitting the vehicle start signal.

14. The watch type terminal of claim 13, wherein the vehicle start signal includes ID information of the vehicle, and
wherein the controller is further configured to generate the vehicle starting control command when the vehicle ID information matches a vehicle ID of the stored particular vehicle.

15. The watch type terminal of claim 13, wherein the controller is further configured to prompt a user wearing the watch type terminal for desired destination information when the navigation mode is activated.

16. The watch type terminal of claim 12, wherein the first control command unlocks the lock state of the display unit before transmitting the vehicle starting control command or activating the navigation mode, and
wherein the second control command maintains the lock state of the display when transmitting the vehicle starting control command.

17. A watch type terminal, comprising:
a main body having a first area and a second area;
a wireless communication unit mounted on the main body and configured to perform wireless communications with a vehicle;
a display unit disposed in the first area;
a button unit disposed in the second area and configured to receive a control command;
a camera mounted on the main body and configured to acquire iris information in response to the received control command; and
a controller configured to:
in response to the acquired iris information matching stored iris information, determine if a vehicle start signal has been received from the vehicle,
in response to determining the vehicle start signal has been received, transmit a vehicle starting control command to the vehicle for starting the vehicle, and
in response to determining the vehicle start signal has not been received, activate a navigation mode on the display unit.

18. The watch type terminal of claim 17, further comprising:
a memory storing the iris information in association with a particular vehicle,
wherein the controller is further configured to transmit the vehicle starting control command to the vehicle when the stored particular vehicle matches the vehicle transmitting the vehicle start signal

19. The watch type terminal of claim 17, wherein the camera is disposed at a boundary between the first area and second area.

20. The watch type terminal of claim 17, wherein the controller is further configured to display an iris guide image while acquiring the iris information by the camera.

21. A watch type terminal, comprising:
a main body having a first area and a second area;
a display unit disposed in the first area;
a button unit disposed in the second area and configured to receive a control command;
a sensor unit configured to sense a relative movement of the watch type terminal with respect to a wrist of a user wearing the watch type terminal; and
a controller configured to:
in response to the sensor unit sensing the button unit being located in a first position on the wrist, activate a first mode for receiving a control command on the button unit and executing a specific function in accordance with the received control command, and
in response to the sensor unit sensing the button unit being moved to a second position on the wrist due to the relative movement of the watch type terminal such that the display unit is located in the first position, activate a second mode for displaying navigation screen information on the display unit.

22. The watch type terminal of claim 21, wherein the controller is further configured to block reception of the control command by the button unit in the second mode.

23. The watch type terminal of claim 21, wherein the first position on the wrist is a position facing the user.
